(19) United States
(12) Patent Application Publication
(10) Pub. No.: US 2024/0076188 A1
(43) Pub. Date: Mar. 7, 2024

(54) METHODS AND SYSTEMS FOR PRODUCING DISPERSED GRAPHENE FROM SPENT LITHIUM-ION BATTERIES

(71) Applicant: University of Virginia Patent Foundation, Charlottesville, VA (US)

(72) Inventors: Xiaodong Li, Charlottesville, VA (US); Yucheng Zhou, Charlottesville, VA (US); Zan Gao, Charlottesville, VA (US)

(21) Appl. No.: 18/273,658

(22) PCT Filed: Jan. 24, 2022
(86) PCT No.: PCT/US2022/013542

§ 371 Date: Jul. 21, 2023

Related U.S. Application Data
(60) Provisional application No. 63/140,492, filed on Jan. 22, 2021.

(51) Int. Cl. C01B 32/19; C01B 32/225; H01M 10/54

(52) U.S. Cl. CPC C01B 32/19; C01B 32/225; H01M 10/54; C01P 2002/01; C01P 2002/72; C01P 2004/03

(57) ABSTRACT

Methods and systems for producing graphene from spent lithium-ion batteries are disclosed. One method includes applying an acid leaching solution to an anode of a lithium-ion battery to produce expanded graphite, applying a hydrothermal process to the expanded graphite to produce purified graphite, and subjecting the purified graphite to a shear mixing process to produce dispersed graphene. In some examples, the shear mixing process is combined with a hydrogen passivation process, which collectively improves each of graphene quality, graphene conversion rate, and graphene production efficiency.

### CROSS REFERENCE TO RELATED APPLICATIONS

This application claims benefit of U.S. Provisional Application Ser. No. 63/140,492 filed on Jan. 22, 2021, the disclosure of which is incorporated herein by reference in its entirety.

### GOVERNMENT INTEREST

This invention was made partially with government support under Grant No. 1728042 awarded by the National Science Foundation. The government has certain rights in the invention.

### TECHNICAL FIELD

The subject matter described herein relates to recycling the anodes of lithium-ion batteries. More particularly, the subject matter described herein relates to methods and systems for producing dispersed graphene from spent lithium-ion batteries.

### BACKGROUND

Lithium-ion batteries have transformed society and revolutionized the quality of life for many people today. As a result of the ever increasing production and usage of lithium-ion batteries, a significant number of retired batteries have been abandoned and discarded in landfills without any recycling efforts. This common practice has unfortunately created a number of serious social and environmental issues. Moreover, it is worth noting that graphite, which is the most commonly used anode material for lithium-ion batteries, is difficult to obtain due to its limited supply and accessibility. Accordingly, the lack of graphite supply presents an immediate challenge towards satisfying the growing requirements and needs of the lithium battery manufacturing industry. In order to meet the manufacturers' demands for graphite, methods of recycling graphite and subsequently deploying the recycled material for use in high value-added products are being explored. However, many of these techniques are presently too costly or environmentally harmful themselves. As such, there exists a need for producing graphene from spent lithium-ion batteries at a cost efficient and environmentally friendly manner.

### SUMMARY

Methods for producing graphene from spent lithium-ion batteries are disclosed. One example method includes applying an acid leaching solution to an anode of a lithium-ion battery to produce expanded graphite, applying a hydrothermal process to the expanded graphite to produce purified graphite, and subjecting the purified graphite to a shear mixing process combined with a hydrogen passivation process to produce dispersed graphene.

According to an aspect of the subject matter described herein, the acid leaching solution includes a hydrogen peroxide solution and a sulfuric acid solution.

According to an aspect of the subject matter described herein, the acid leaching solution is configured to remove chemical impurities from the expanded graphite.

According to an aspect of the subject matter described herein, the chemical impurities include one or more of cobalt, nickel, manganese, copper, sulfur, and aluminum.

According to an aspect of the subject matter described herein, the expanded graphite is characterized by a graphene plane layer spacing that is swollen and/or extended.

According to an aspect of the subject matter described herein, the hydrothermal process includes an application of a sodium hydroxide solution to the expanded graphite.

According to an aspect of the subject matter described herein, graphene plane layers of the purified graphite are further expanded after being exposed to the sodium hydroxide solution.

According to an aspect of the subject matter described herein, the graphene plane layers include an average d-spacing of 0.374 nanometers.

According to an aspect of the subject matter described herein, the purified graphite is devoid of organic binder material and aluminum after the application of the sodium hydroxide solution.

According to an aspect of the subject matter described herein, the purified graphite includes purified graphite powder.

According to an aspect of the subject matter described herein, the shear mixing process exfoliates the purified graphite.

According to an aspect of the subject matter described herein, the shear mixing process is enhanced by a hydrogen passivation process.

According to an aspect of the subject matter described herein, the hydrogen passivation process applies hydrogen gas to facilitate the graphene exfoliation and dispersion.

Another exemplary method includes applying an acid leaching solution to an anode of a lithium-ion battery to produce expanded graphite, applying a hydrothermal process to the expanded graphite to produce purified graphite, and subjecting the purified graphite to a shear mixing process to produce dispersed graphene.

According to an aspect of the subject matter described herein, the acid leaching solution includes a hydrogen peroxide solution and a sulfuric acid solution.

According to an aspect of the subject matter described herein, the acid leaching solution is configured to remove chemical impurities from the expanded graphite.

According to an aspect of the subject matter described herein, the chemical impurities include one or more of cobalt, nickel, manganese, copper, sulfur, and aluminum.

According to an aspect of the subject matter described herein, the expanded graphite is characterized by a graphene plane layer spacing that is swollen and/or extended.

According to an aspect of the subject matter described herein, the hydrothermal process includes an application of a sodium hydroxide solution to the expanded graphite.

According to an aspect of the subject matter described herein, graphene plane layers of the purified graphite are further expanded after being exposed to the sodium hydroxide solution.

According to an aspect of the subject matter described herein, the graphene plane layers include an average d-spacing of 0.374 nanometers.

According to an aspect of the subject matter described herein, the purified graphite is devoid of organic binder material and aluminum after the application of the sodium hydroxide solution.

According to an aspect of the subject matter described herein, the purified graphite includes purified graphite powder.

According to an aspect of the subject matter described herein, the shear mixing process exfoliates the purified graphite.

According to an aspect of the subject matter described herein, the shear mixing process is enhanced by a hydrogen passivation process.

According to an aspect of the subject matter described herein, the hydrogen passivation process applies hydrogen gas to facilitate the graphene exfoliation and dispersion.

In another embodiment, a dispersed graphene product is produced. For example, dispersed graphene is produced by a process comprising: applying an acid leaching solution to an anode of a lithium-ion battery to produce expanded graphite, applying a hydrothermal process to the expanded graphite to produce purified graphite, and subjecting the purified graphite to a shear mixing process, whereby the dispersed graphene is produced. In some embodiments, the shear mixing process is combined with a hydrogen passivation process to produce the dispersed graphene.

As used herein, the term “purified graphite” may be used to define graphite with a carbon ratio larger than 92 wt % and having few impurities. It is obtained after both acid leaching and alkaline hydrothermal process.

As used herein, the term “dispersed graphene” may be used to define the graphene that is obtained after shear mixing process (optionally coupled with hydrogen passivation process). It is dispersed and can be stored in deionized water (or any other similar pure water).

As used herein, the term “swollen graphite” may be extended and/or expanded graphite, which has expanded graphene layers (e.g., the distance between two layers is larger than the normal 0.335 nanometers) and is obtained after the acid leaching process.

As used herein, the phrases “further extended graphite” or “further expanded graphite” may be used to define graphite obtained after both the acid leaching process and the alkaline hydrothermal process and has further expanded graphene layers (e.g., the distance between two layers is larger than expanded graphite).

### BRIEF DESCRIPTION OF THE DRAWINGS

Preferred embodiments of the subject matter described herein will now be explained with reference to the accompanying drawings, wherein like reference numerals represent like parts, of which:

FIG. 1 depicts a block diagram of an example graphite purification and graphene production process according to an embodiment of the subject matter described herein;

FIG. 2 depicts a plurality of images of processed recycled graphite according to an embodiment of the subject matter described herein; and

FIG. 3 depicts a flow chart illustrating an exemplary method for purifying graphite to produce graphene according to an embodiment of the subject matter described herein.

### DETAILED DESCRIPTION

The lithium-ion (Li-ion) battery has been employed as the major energy storage system due to its high energy density, long lifespan, and outstanding stability. Considering the ever-increasing electric vehicle (EV) market, the Li-ion battery industry has the potential of continuing its rapid expansion. However, accompanying the booming expansion of the Li-ion battery market, a tremendous amount of batteries retire every year and most of them are disposed in landfills, which not only causes severe waste of precious sources but also induces hazardous soil contamination due to the plastic components and toxic electrolytes. So far, only 1% of end-of life Li-ion batteries have been recycled. As such, it is imperative to develop effective battery recycling techniques. Several strategies for recycling metallic parts, such as Cu, Fe, Al, and cathode materials from end-of-life Li-ion batteries have been designed.

Graphene, which comprises a single layer of carbon atoms, is known for its outstanding mechanical and electronic properties, thereby making graphene a promising material for numerous applications, especially for future industrial development. Since its initial discovery, multiple methods have been developed to produce graphene. For example, chemical vapor deposition (CVD) can produce large, intact graphene. However, the graphene synthesized by the CVD method, which is expensive and inefficient, is difficult to separate from the substrate for further applications. One alternative is to fabricate graphene oxide by exfoliating graphite via strong oxidation agents (i.e., Hummers' method). However, this process will inevitably lead to a destruction of the crystal structure, largely deteriorating the mechanical properties of graphene. Moreover, the consumption of strong oxidants and the complicated procedures increase the cost, which has largely hindered the scale-up needed for industrial production.

In addition to all of the aforementioned technical difficulties, the raw material, graphite, is a nonrenewable resource while the mining of graphite causes severe environmental pollution, leaving irreversible damage to the landscape. A rational strategy to simultaneously solve the environmental issues from waste batteries and graphite mining is to fabricate graphene directly from end-of-life battery anodes. Unlike cathode materials, recycling of graphite anode has received little attention. The disclosed subject matter aims to remedy these deficiencies in the current state of the art.

In particular, the disclosed subject matter describes method and systems for producing high-quality graphene from spent lithium-ion battery anodes. In some embodiments, recycled graphite anodes are initially purified using both an acid leaching method and a hydrothermal process, which collectively eliminates a number of different chemical impurities present in the graphite. Specifically, spent graphite anodes that are recycled from lithium-ion batteries contain a significant amount of metallic impurities, including cobalt (Co), nickel (Ni), aluminum (Al), sulfur (S), and/or and manganese (Mn). Furthermore, lithium-ion batteries also include a significant amount of copper (Cu) impurities originating from substrates, organic binders, and other byproducts that are produced during battery operation. Additional impurities may also be present due to the battery shredding process. After the purification processing is performed on the recycled graphite anode material, the resulting purified graphite material can be subjected to a shear mixing method that can produce high-quality graphene with a high throughput (e.g., 500 milliliters of graphene solution with a concentration of 0.5 g/L daily). Additionally, the shear mixing process can also be (optionally) coupled and/or combined with a hydrogen passivation process, which significantly improves each of the graphene quality, graphene conversion rate, and graphene production efficiency. Various embodiments of the disclosed subject matter are described in detail below.

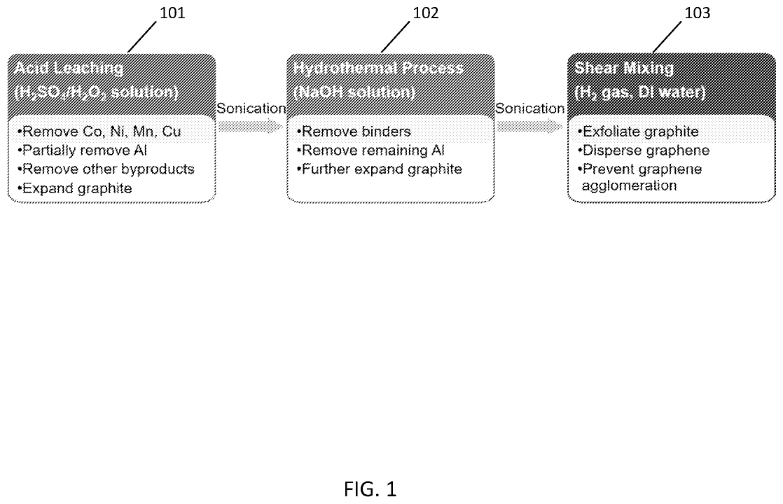

FIG. 1 depicts a block diagram of an example graphite purification and graphene production process according to an embodiment of the subject matter described herein. Namely, block 101 indicates an acid leaching processing step that is initially performed on the recycled graphite material that has been extracted from lithium-ion battery anodes (e.g., anodes obtained after preliminary battery shredding process). In some embodiments, the graphite anode material of spent lithium-ion batteries can be exposed and/or subjected to acid leaching via a mixture including a sulfuric acid solution (e.g., H₂SO₄) and a hydrogen peroxide solution (e.g., H₂O₂ solution). For example, the impure graphite material can be placed in a glass container along with the aforementioned mixture solution. In some embodiments, a mixture solution of 2 molar (M) H₂SO₄ and 37 wt % H₂O₂ with a volume ratio of 5:1 is applied to the impure graphite. In some embodiments, the mixture solution may have a concentration ranging from 2M-4M. Further, the concentration of H₂O₂ can range between 30-40 wt %. For embodiments where a different concentration is utilized, the volume ratio is adjusted accordingly. For example, if a 4M H₂SO₄ and 30 wt % H₂O₂ solution is used, the volume ratio is adjusted to 2:1 (e.g., instead of 5:1). Notably, a number of combinations of different solutions and concentrations that are mutually correlated can be utilized without departing from the scope of the disclosed subject matter.

Notably, chemical impurities that are present in the graphite of the spent lithium-ion batteries can be removed by conducting the disclosed acid leaching procedure using the mixture of the sulfuric acid and hydrogen peroxide solutions. For example, chemical impurities such as cobalt, nickel, manganese, aluminum, and other byproducts can be removed from the graphite material utilizing the acid leaching mixture solution, thereby largely purifying and expanding the graphite material. In some embodiments, the sulfuric acid solution and the hydrogen peroxide solution can be mixed together (e.g., in a glass container) and heated to 60-90° C. to leach the graphite for at least two hours. Notably, if a lower temperature in this range is used, the leaching time is increased. For example, if the graphite is acid leached at 60° C., the process may take 3 hours.

In some embodiments, the mixed solution may also be subjected to some form and/or frequency of sonication or ultrasonication, which serves to agitate or stir the graphite material in the mixed solution for the next step(s).

In addition to purifying the graphite when subjected to the acid leaching process, the acid leaching mixture solution can further expand (e.g., extend, separate, and/or swell) the graphene plane layers of the graphite material. In some embodiments, the average d-spacing for acid leached graphite may be approximately 0.352 nanometers (e.g., a 3.5% increase as compared to the d-spacing of normal graphite). By expanding the d-spacing between the graphene plane layers, the rate performance of subsequent manufactured batteries can be later improved by using the recycled graphite. After the acid leaching process is finished, the leached and expanded graphite (e.g., graphite powder) is washed with de-ionized (DI) water (or any other similar pure water) and is permitted to dry for a number of hours (e.g., overnight). Notably, at this stage most of the impurities in the leached graphite have been removed, but some remnants of aluminum and binders still remain.

In block 102, the expanded graphite material is subjected to a hydrothermal process. Notably, the remaining dry graphite powders (e.g., “expanded graphite”) produced from the previous block 101 are added to a sodium hydroxide solution (e.g., NaOH solution) and subsequently well sonicated (or ultrasonicated). In some embodiments, the sodium hydroxide solution has a concentration of no less than 8M. Once the expanded graphite is added to the sodium hydroxide solution, the resulting mixture is stirred well. In some embodiments, sonication can be used. At this stage, the resulting mixture is subjected to an alkaline hydrothermal process. For example, the mixture may be heated at a temperature of 180 degrees Celsius (C) for six hours in order to eliminate the remaining organic binder material and aluminum impurities present in the graphite material. In some embodiments, the hydrothermal process can be conducted between the temperature range of 160 to 180 degrees Celsius.

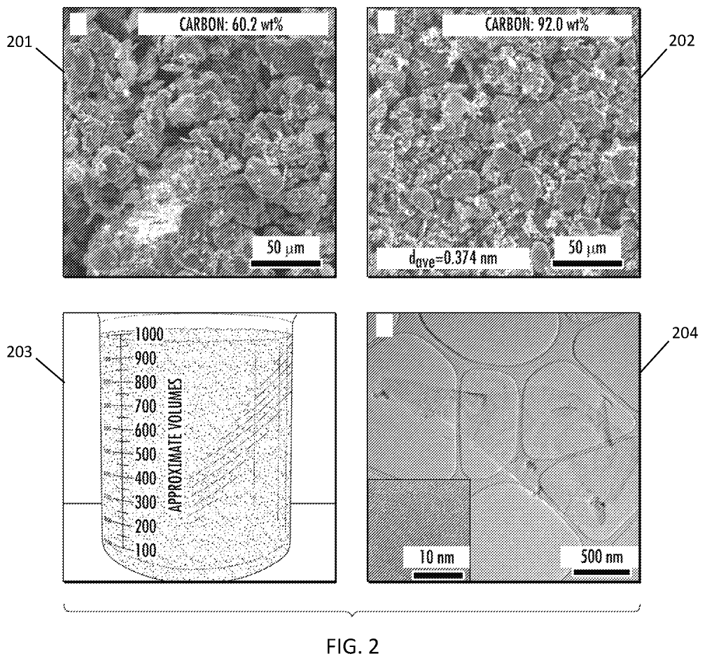

During this hydrothermal process, the graphene plane layers of the graphite are further extended, swollen, and/or expanded. In some embodiments, the resulting purified graphite product may retain a carbon ratio of more than 92.0 wt % (e.g., a range of 92 wt % to 95 wt %). Referring to FIG. 2, image 202 depicts an scanning electron microscopy (SEM) image of recycled graphite product after the aforementioned purification process is conducted. Notably, the purification process has significantly increased carbon ratio (e.g., 60.2 wt % to 92.0 wt %) as compared to image 201, which depicts an example SEM image of the recycled graphite material before the purification processing is conducted.

Image 202 further illustrates purified graphite with an average d-spacing between the graphene plane layers of approximately 0.374 nanometers (nm) (e.g., since the obtained expanded graphite (further expanded graphite) has a uniform structure, d-spacing is too small to determine a range that deviates to much from 0.374 nm in the high-resolution TEM image). Notably, this average d-spacing is indicative of an approximate 11.6% increase in the lattice expansion of the graphite material. Once the hydrothermal stage purification process is completed, the obtained purified graphite is thoroughly washed with deionized water (or any other similar pure water) and permitted to air dry for a number of hours (e.g., any amount of time needed for the quantity of graphite to completely dry).

The above-mentioned purification technique removes a significant amount of impurities from the graphite material. For example, Table 1 below summarizes the exemplary energy-dispersive X-ray spectroscopy (EDS) data of chemical impurities associated with recycled graphite before purification processing and after purification processing. In particular, Table 1 indicates the respective percentages by weight (wt %) of cobalt, nickel, manganese, aluminum, fluorine, and sulfur that are present in each of the raw graphite and the resulting purified graphite material.

TABLE 1
EDS data of recycled graphite impurities
before and after purification.

| Element | Co | Ni | Mn | Al | F | S |
|---|---|---|---|---|---|---|
| Raw graphite (wt %) | 7.2 | 3.3 | 3.3 | 0.8 | 1.6 | 4.9 |
| Purified graphite (wt %) | 0.0 | 0.0 | 0.0 | 0.0 | 0.3 | 0.0 |

Returning to FIG. 1, block 103 indicates that the purified graphite material is subjected to a shear mixing process. Specifically, the purified graphite product resulting from block 102 undergoes a facile shear mixing procedure (e.g., inserting a shear mixing device into a mixture of deionized water (or any other similar pure water) and the purified graphite material). In some embodiments, the purified graphite products may be shear mixed at no less than 3600 rpm for over four hours in deionized water or pure water. To illustrate, image 203 of FIG. 2 depicts an image of shear mixed graphene dispersion in deionized water (or any other similar pure water). Since the graphene plane layers of the graphite material have already been extended and/or expanded during the previous purification processes, the shear mixing method is able to facilitate the conversion of the purified graphite material into a high quality graphene. More specifically, the shear mixing process effectively exfoliates layers of the graphite in order to produce a high quality dispersed graphene. In FIG. 2, image 204 depicts a transmission electron microscopy (TEM) image of an obtained graphene piece after shear mixing (as well as an inset of a high resolution image of the same graphene piece).

In some alternate embodiments, the purified graphite material may be subjected to a shear mixing process that is combined or coupled with a hydrogen passivation process. In particular, contemporaneously adding a hydrogen passivation process to the aforementioned shear mixing process improves each of the graphene quality, graphene conversion rate, and graphene production efficiency. In some embodiments, with the assistance of the hydrogen passivation process, the graphene conversion rate can be improved from 25 wt % to 35 wt % or higher (i.e., where the percentage indicates the increased amount of graphite that was converted to graphene by shear mixing). In some embodiments, the hydrogen passivation process entails the application of a hydrogen gas flow to the purified graphite during the shear mixing process. For example, the purified graphite product may be shear mixed at no less than 3600 rpm for four hours in deionized water (or any other similar pure water) that is being subjected to a flow of hydrogen gas (e.g., H₂ gas), which effectively aerates the deionized water or pure water. In some embodiments, the applied H₂ gas may be produced by a reaction resulting from a combination of aluminum foils and a 2M hydrochloride acid solution (e.g., HCl solution). Alternatively, the H₂ gas may be provided directly from a H₂ gas tank or a similar source. Implementing the hydrogen passivation process in this manner improves the graphene quality by preventing graphene clusters. Further, combining the hydrogen passivation process with the shear mixing process notably produces high quality monolayer graphene.

In particular, the shear mixing method facilitates the conversion of the purified graphite material into high quality graphene since the graphene plane layers of the graphite material have been extended and/or expanded during the previous purification processes. Moreover, the combining and/or coupling of the shear mixing process with hydrogen passivation enhances the production of high quality graphene. In particular, the shear mixing process effectively exfoliates the graphite while the H₂ gas flow further facilitates graphene exfoliation and prevents graphene agglomeration, thereby producing high quality dispersed graphene.

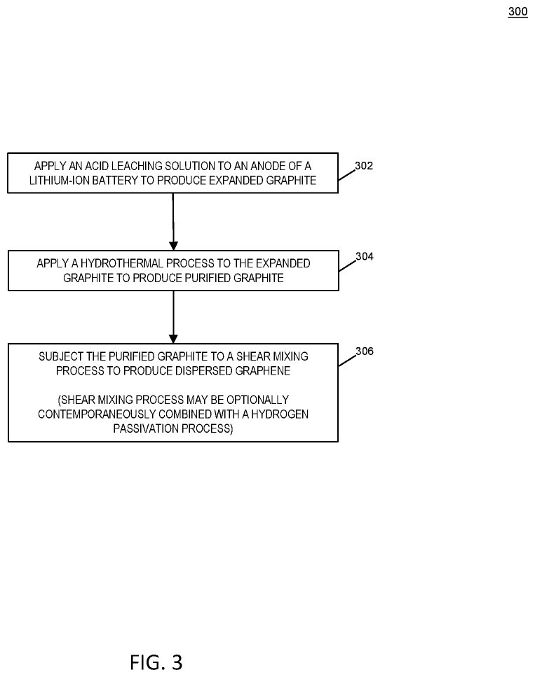

FIG. 3 is a flow chart illustrating an example process for producing graphene from spent lithium-ion battery anodes according to an embodiment of the subject matter described herein. In some embodiments, blocks 302-306 of method 300 depicted in FIG. 3 can be performed manually or by an automated mechanical system that is configured to execute blocks 302-306 via an algorithm or software program. Notably, method 300 can be performed in any laboratory environment using standard laboratory equipment.

In block 302, an acid leaching solution is applied to an anode of a lithium-ion battery to produce expanded graphite. In some embodiments, one or more lithium-ion batteries are processed (e.g., shredded) such that the graphite anode material is obtained. The graphite material may then be placed in an acid leaching solution comprising a mixture of sulfuric acid and hydrogen peroxide. Notably, subjecting the graphite material to the acid leaching solution removes a number of chemical impurities and other byproducts as well as expanding the lattice layers of the graphite. The mixture of the acid leaching solution and graphite can also be subjected to some form of sonication or ultrasonication at this stage.

In block 304, a hydrothermal process is applied to the expanded graphite to produce purified graphite. In some embodiments, the expanded graphite produced in block 302 is applied to a sodium hydroxide solution. This solution, with the addition of heat, can be used to remove binder material and aluminum from the graphite material. Moreover, the hydrothermal process may also further expand the lattice layers of the graphite. The mixture of the sodium hydroxide solution and expanded graphite can also be subjected to some form of sonication or ultrasonication at this stage.

In block 306, the purified graphite is subjected to a shear mixing process to produce dispersed graphene. In some embodiments, the purified graphite is placed in a container and mixed with deionized water (or any other similar pure water) by a shear mixing device or apparatus. Notably, the water used at this stage (and other stages) should be a purified water without any impure ions, which can form functional groups on graphene and/or cause agglomeration. In some embodiments, the shear mixing process can be combined with a hydrogen passivation process. In particular, the combination of shear mixing and hydrogen passivation processes allows for improved graphene quality (e.g., greater graphene exfoliation that yields purified monolayer graphene) and prevents graphene agglomeration or clustering.

Using the methodology of FIG. 3 as an example, 10 grams of shredded graphite was added to a 200 mL 2M H₂SO₄ with 40 mL 37 wt % H₂O₂ mixture and constantly stirred at 80° C. for 2 hours to eliminate Co, Ni, Mn, Cu and/or S impurities and partially remove Al and binders (e.g., see block 301). After filtration and washing with deionized water, the graphite was placed in a drying oven to be dried at 60° C. overnight. The acid leached graphite was then placed in a crucible filled with an 8M NaOH solution for a hydrothermal process that can be conducted at 180° C. for 6 hours to harvest purified graphite (e.g., see block 302). After filtration, washing, and drying again, one gram of purified graphite was moved to a beaker filled with deionized water to perform sonication for 20 minutes and then shear mixed at 3600 rpm for 5 hours. During shear mixing, a tube was inserted into the beaker to constantly provide hydrogen gas to achieve hydrogen passivation for better shear mixing and dispersion (e.g., see block 303). After allowing the beaker to sit on a table overnight, the supernatant deionized water mixed with well-dispersed graphene was collected and the sediment (e.g., leftover graphite) was used for a next round of shear mixing.

The disclosed subject matter presents a number of technological advancements over the current state-of-the-art battery anode recycling methods. As indicated above, the disclosed methodology includes a two-step purification process (e.g., i) an acid leaching process and ii) an alkaline hydrothermal method) that is conducted prior to a shear mixing method. In some embodiments, the shear mixing process can be combined and/or coupled with a hydrogen passivation process.

These disclosed techniques significantly reduce the complexity and cost of graphite anode recycling and graphene production. In particular, the sodium hydroxide used in the disclosed alkaline hydrothermal method removes stubborn aluminum impurities that cannot be separated via commonly used organic solutions. Further, the disclosed method utilizes low-cost chemicals that are environmentally friendly and can be readily utilized in mass production. For example, binder removal process that is conducted using a NaOH solution reduces the cost and/or obviates the need for using other expensive organic solutions, such as N-Methyl-2-pyrrolidone (NMP), which notably increases the overall cost of purification processes that are currently being employed by the recycling industry.

The hydrothermal method further obviates the need for high temperature annealing, which causes graphene plane layer spacing reduction as well as other graphite exfoliation difficulties. Specifically, the entire liquid condition in the lower temperature requirement of the disclosed purification methods (as compared to common annealing processes) maintains the well-expanded status of the purified graphite. As such, this technique readily promotes graphene exfoliation of purified graphite when subsequently shear mixed. Moreover, the addition of hydrogen passivation to the shear mixing process provides a number of improvements. For example, applying and/or inletting an H₂ gas flow to shear mixing process further improves graphene quality and prevents graphene agglomeration.

Considered in its entirety, the disclosed subject matter provides a novel method that achieves highly efficient and low-cost graphene production of high quality from the anodes of spent lithium-ion batteries, thereby providing a practical implementation that achieves a waste to wealth circular economy in the lithium battery industry. In particular, this can be achieved because the disclosed process(es) can be readily incorporated and/or inserted into an existing battery recycling processing line.

It is further contemplated that the resulting recycled graphite from the spent lithium-ion battery anodes can help meet the increasing demand for graphite anodes existing in the current lithium battery market. As indicated above, the recycled graphite also has expanded or extended d-spacing, which will likely improve the rate performance of the produced lithium batteries. The recycled graphite can also be used for batteries beyond lithium-ion batteries, such as sodium-ion, potassium-ion, and lithium sulfur batteries. Lastly, high-quality graphene produced from spent lithium-ion anodes using the disclosed subject matter can find other versatile non-battery applications, such as composites, smart textiles, sensors, and other electronics.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for producing graphene from spent lithium-ion batteries, the method comprising:
applying an acid leaching solution to an anode of a lithium-ion battery to produce expanded graphite;
applying a hydrothermal process to the expanded graphite to produce purified graphite; and
subjecting the purified graphite to a shear mixing process contemporaneously combined with a hydrogen passivation process to produce dispersed graphene.

2. The method of claim 1 wherein the acid leaching solution includes a hydrogen peroxide solution and a sulfuric acid solution.

3. The method of claim 1 wherein the acid leaching solution is configured to remove chemical impurities from the expanded graphite.

4. The method of claim 3 wherein the chemical impurities include one or more of cobalt, nickel, manganese, copper, sulfur, and aluminum.

5. The method of claim 1 wherein the expanded graphite is characterized by a graphene plane layer spacing that is swollen and/or extended.

6. The method of claim 1 wherein the hydrothermal process includes an application of a sodium hydroxide solution to the expanded graphite.

7. The method of claim 6 wherein graphene plane layers of the purified graphite are further expanded after being exposed to the sodium hydroxide solution.

8. The method of claim 7 wherein the graphene plane layers include an average d-spacing of 0.374 nanometers.

9. The method of claim 6 wherein the purified graphite is devoid of organic binder material and aluminum after the application of the sodium hydroxide solution.

10. The method of claim 6 wherein the purified graphite includes purified graphite powder.

11. The method of claim 1 wherein the shear mixing process exfoliates the purified graphite.

12. The method of claim 1 wherein the hydrogen passivation process is combined with the shear mixing process by applying a hydrogen gas flow to the purified graphite during the shear mixing process.

13. The method of claim 1 wherein each of graphene quality, graphene conversion rate, and graphene production efficiency is improved by the hydrogen passivation process.

14. The method of claim 1 wherein the hydrogen passivation process prevents graphene agglomeration.

15. A method for producing graphene from spent lithium-ion batteries, the method comprising:
applying an acid leaching solution to an anode of a lithium-ion battery to produce expanded graphite;
applying a hydrothermal process to the expanded graphite to produce purified graphite; and
subjecting the purified graphite to a shear mixing process to produce dispersed graphene.

16. The method of claim 15 wherein the acid leaching solution includes a hydrogen peroxide solution and a sulfuric acid solution.

17. The method of claim 15 wherein the acid leaching solution is configured to remove chemical impurities from the expanded graphite.

18. The method of claim 17 wherein the chemical impurities include one or more of cobalt, nickel, manganese, copper, sulfur, and aluminum.

19. The method of claim 15 wherein the expanded graphite is characterized by a graphene plane layer spacing that is swollen and/or extended.

20. The method of claim 15 wherein the hydrothermal process includes an application of a sodium hydroxide solution to the expanded graphite.

21. The method of claim 20 wherein graphene plane layers of the purified graphite are further expanded after being exposed to the sodium hydroxide solution.

22. The method of claim 21 wherein the graphene plane layers include an average d-spacing of 0.374 nanometers.

23. The method of claim 20 wherein the purified graphite is devoid of organic binder material and aluminum after the application of the sodium hydroxide solution.

24. The method of claim 20 wherein the purified graphite includes purified graphite powder.

25. The method of claim 15 wherein the shear mixing process exfoliates the purified graphite.
